(19) United States
(12) Patent Application Publication
(10) Pub. No.: US 2011/0218259 A1
(43) Pub. Date: Sep. 8, 2011

(54) PREPARING POLYURETHANES

(75) Inventors: Berend ELING, Lemfoerde (DE); Markus SCHÜTTE, Osnabrueck (DE); Sirus ZARBAKHSH, Birkenheide (DE)

(73) Assignee: BASF SE, Ludwigshafen (DE)

(21) Appl. No.: 13/037,558

(22) Filed: Mar. 1, 2011

Related U.S. Application Data
(60) Provisional application No. 61/309,469, filed on Mar. 2, 2010.

(51) Int. Cl. C08J 9/35; C08K 9/10; C08K 3/32; C08K 3/34; B82Y 30/00

(52) U.S. Cl. 521/106; 521/129; 521/122; 977/742

(57) ABSTRACT

The invention relates to a process for preparing polyurethanes, which comprises reacting
a) polyisocyanates with
b) compounds having at least two hydrogen atoms reactive with isocyanate groups,

wherein said compounds having at least two hydrogen atoms reactive with isocyanate groups b) comprise at least one polyether alcohol b1) having a functionality of 2-8 and a hydroxyl number of 200-600 mgKOH/g, obtained by addition of an alkylene oxide b1b) onto a compound having at least two hydrogen atoms reactive with alkylene oxides by using an amine b1c) as catalyst.

The present invention relates to a process for preparing polyurethanes by reaction of polyisocyanates with compounds having at least two hydrogen atoms reactive with isocyanate groups.

Polyurethanes are long known and are extensively described in the literature. They are typically prepared by reaction of polyisocyanates with compounds having at least two hydrogen atoms reactive with isocyanate groups.

Polyurethanes can be used in many technical fields. The starting compounds can be varied to prepare polyurethanes having different properties. Polyurethanes thus provided can be compact or else, through the use of blowing agents, foamed.

Since the number of commercially available polyisocyanates is limited, the different properties of polyurethanes are preferably achieved by varying the compounds having at least two hydrogen atoms reactive with isocyanate groups.

The compounds having at least two hydrogen atoms reactive with isocyanate groups are polyfunctional alcohols in most cases. Polyether alcohols have the greatest industrial importance as well as polyester alcohols.

Polyether alcohols are mostly prepared by addition of alkylene oxides, preferably ethylene oxide and/or propylene oxide, onto polyfunctional alcohols and/or amines. The addition reaction is typically carried out in the presence of a catalyst.

All these processes are known to a person skilled in the art.

It is a constant objective to improve the processing properties and the product properties of polyurethanes. This, as explained, is essentially possible via the modification of polyether alcohols. This modifying can be effectuated in the nature of the polyols used themselves, but also through the use of added substances.

It is an object of the present invention to provide a process for preparing polyurethanes which is characterized by improved flowability of the components. The components should have a very low viscosity and be efficiently pumpable at low temperatures. The components should still have a processable viscosity after loading with fillers. Furthermore, the components should have good solubility for blowing agents, more particularly hydrocarbons, and improved compatibility with isocyanate. The resulting polyurethanes should have low emissions and a uniform structure, more particularly be free of voids and flaws at the surface.

We have found that this object is achieved, surprisingly, by using a polyol component comprising at least one polyether alcohol obtained using an amine as catalyst.

US 20070203319 and US 20070199976 describe polyether alcohols obtained by addition of alkylene oxides by means of dimethylethanolamine onto starter substances comprising solid compounds at room temperature. However, polyurethanes obtained using these polyols are not described.

The present invention accordingly provides a process for preparing polyurethanes, which comprises reacting

a) polyisocyanates with
b) compounds having at least two hydrogen atoms reactive with isocyanate groups,
wherein said compounds having at least two hydrogen atoms reactive with isocyanate groups b) comprise at least one polyether alcohol b1) having a functionality of 2-8 and a hydroxyl number of 200-800 mgKOH/g, obtained by addition of an alkylene oxide b1b) onto a compound having at least two hydrogen atoms, hereinafter also known as starter substances, reactive with alkylene oxides by using an amine b1c) as catalyst.

The polyether alcohol b1) can be used as sole compound of component b).

Preferably, the polyether alcohol b1) is used in an amount of 10-90% by weight, based on the weight of component b).

Preferably, the compound having at least two hydrogen atoms reactive with alkylene oxides used for preparing the polyether alcohol b1) comprises a mixture comprising at least one compound b1ai) which is solid at room temperature.

Compounds of this type are known and are frequently used in the manufacture of polyether alcohols, particularly those for use in rigid polyurethane foams. They are preferably selected from the group comprising trimethylolpropane, pentaerythritol, glucose, sorbitol, mannitol and sucrose, polyhydric phenols, resols, for example oligomeric condensation products of phenol and formaldehyde, oligomeric condensation products of aniline and formaldehyde (MDA), toluenediamine (TDA) and Mannich condensates of phenols, formaldehyde and dialkanolamines, and also melamine and also mixtures of at least two of the alcohols listed.

In a preferred embodiment of the invention, compound b1ai) is selected from the group comprising sucrose, sorbitol and pentaerythritol, more preferably sucrose or sorbitol. In a particularly preferred embodiment of the invention, b1ai) is sucrose.

The aromatic amines used as compounds b1ai) are more particularly selected from the group comprising toluenediamine (TDA) or diphenylmethane diisocyanate (MDA) or polymeric MDA (p-MDA). In the case of TDA it is more particularly the 2,3- and 3,4-isomers, also known as vicinal TDA, which are used.

Useful starter substances b1a) further include compounds having at least two hydrogen atoms reactive with alkylene oxides that comprise at least one compound b1aii) which is liquid at room temperature.

In a preferred embodiment of the invention, the starter substance of component b1) comprises a room temperature liquid compound b1aii) comprising hydrogen atoms reactive with alkylene oxides as well as the compound b1ai).

The compound b1aii) may comprise alcohols or amines. These have more particularly 1 to 4 and preferably 2 to 4 hydrogen atoms reactive with alkylene oxides.

The compound (b1aii) is preferably selected from the group comprising glycerol, monofunctional alcohols of 1-20 carbon atoms, ethanol, propylene glycol and its higher homologs, ethylene glycol and its higher homologs and also mono-, di- or trialkanolamines, more particularly glycerol.

In a further embodiment of the invention, the component b1a) comprises a mixture of at least one room temperature solid amine b1ai) and a room temperature liquid alcohol b1aii). The room temperature solid alcohols b1ai) may preferably comprise MDA and polymeric MDA. The room temperature liquid alcohols b1aii) may preferably comprise ethylene glycol and its higher homologs and propylene glycol and its higher homologs. The concentrations of the amine homologs in p-MDA are dependent on the process conditions. In general, the distribution (in weight percent) is as follows:

two-ring MDA: 50-80% by weight
three-ring MDA: 10-25% by weight
four-ring MDA: 5-12% by weight
five- and more highly ringed MDA: 5-12% by weight

A preferred p-MDA mixture has the composition:

two-ring MDA: 50% by weight
three-ring MDA: 25% by weight
four-ring MDA: 12% by weight
five- and more highly ringed MDA: 13% by weight

A further preferred p-MDA mixture has the composition:

two-ring MDA: 80% by weight
three-ring MDA: 10% by weight
four-ring MDA: 5% by weight
five- and more highly ringed MDA: 5% by weight

In a further preferred embodiment of the invention, component b1a) comprises a mixture of at least one room temperature solid alcohol (b1ai) and one room temperature liquid alcohol (b1aii)). The room temperature solid alcohols (b1ai) preferably comprise the sugar alcohols more particularly characterized above, more particularly sucrose. The room temperature liquid compounds (b1aii) preferably comprise at least one compound b1aii) selected from the group comprising glycerol, monofunctional alcohols of 1-20 carbon atoms, ethanol, propylene glycol and its higher homologs, ethylene glycol and its higher homologs and also mono-, di- or trialkanolamines, more particularly glycerol. Component b1a) may also comprise water. When water is used, the amount is more particularly not more than 25% by weight, based on the weight of component b1a).

The room temperature liquid compounds (b1aii), as mentioned, may also comprise compounds having a hydrogen atom reactive with alkylene oxides and 1-20 carbon atoms. Monofunctional alcohols are preferred here, such as methanol, ethanol, propanol, octanol, dodecanol.

Alkylene oxide b1b) preferably comprises propylene oxide, ethylene oxide, butylene oxide, isobutylene oxide, styrene oxide and mixtures of two or more thereof. Preferably, propylene oxide, ethylene oxide or mixtures of propylene oxide and ethylene oxide are used as alkylene oxide b1b). It is particularly preferable to use propylene oxide as alkylene oxide b1b).

Catalyst b1c), as mentioned, comprises an amine other than component b1ai) and b1aii). This amine may comprise primary, secondary or tertiary amines and also aliphatic or aromatic, more particularly tertiary, amines. In a further embodiment, aromatic heterocyclic compounds having at least one, preferably one, nitrogen atom in the ring may be concerned.

The amines b1c) are preferably selected from the group comprising trialkylamines, more particularly trimethylamine, triethylamine, tripropylamine, tributylamine, dimethylalkylamines, more particularly dimethylethanolamine; dimethylethoxyethanolamine, dimethylcyclohexylamine, dimethylethylamine, dimethylbutylamine, aromatic amines, more particularly dimethylaniline, dimethylaminopyridine, dimethylbenzylamine, pyridine, imidazoles (more particularly imidazole, N-methylimidazole, 2-methylimidazole, 4-methylimidazole, 5-methylimidazole, 2-ethyl-4-methylimidazole, 2,4-dimethylimidazole, 1-hydroxypropylimidazole, 2,4,5-trimethylimidazole, 2-ethylimidazole, 2-ethyl-4-methylimidazole, N-phenylimidazole, 2-phenylimidazole, 4-phenylimidazole), guanidine, alkylated guanidines (more particularly 1,1,3,3-tetramethylguanidine), 7-methyl-1,5,7-triazabicyclo[4.4.0]dec-5-ene, amidines (more particularly 1,5-diazobicyclo[4.3.0]non-5-ene, 1,5-diazabicyclo[5.4.0]undec-7-ene).

It is also possible to use mixtures of at least two of the amines mentioned as catalysts.

The catalyst b1c) is dimethylethanolamine in a preferred embodiment of the invention.

The catalyst b1c) is an imidazole in a preferred embodiment of the invention.

The amine is preferably used therein in an amount of 0.01-5.0%, preferably 0.05-3.0% and more preferably 0.1-1.0% by mass based on the overall batch.

To prepare the polyether alcohols b1), the constituents of the starter substance mixture b1a) and b1c) are typically introduced into the reactor and mixed together. Next the mixture is inertized therein. Thereafter, the alkylene oxide is metered.

The addition reaction of the alkylene oxides is preferably carried out at a temperature between 90 and 150° C. and a pressure between 0.1 to 8 bar. The metering of the alkylene oxides is typically followed by a postreaction phase to complete the reaction of the alkylene oxides.

Conclusion of the metering of the alkylene oxides is typically followed by a postreaction phase in which the reaction of the alkylene oxide is taken to completion. This is followed by a postreaction phase, if necessary. This is typically followed by distillation to remove volatiles, which is preferably carried out under reduced pressure.

The aminic catalysts b1c) can remain in the polyether alcohol. This simplifies the process of preparing them, since the removal of catalysts, which is necessary when oxides and hydroxides of alkali metals are used, is no longer necessary. This leads to an improvement in the space-time yield. The salt removal by filtration forms a filter cake. The polyol loss in the filter cake generally amounts to some percent. The improved space-time yield and avoided filter loss contribute to reduced manufacturing costs.

A combination of alkali metal hydroxide catalysts and amine catalysts is also useful. This is particularly an option to prepare polyols of low hydroxyl number. The products obtained can be worked up similarly to the polyols catalyzed with alkali metal hydroxide. Alternatively, they can also be worked up by performing just the neutralization step with an acid. In this case, it is preferable to use carboxylic acids such as for example lactic acid, acetic acid or 2-ethylhexanoic acid.

The aminic catalysts b1c) can themselves be alkoxylated in the course of the reaction. The alkoxylated amines, therefore, have a higher molecular weight and reduced volatility in the later product. Owing to the remaining auto-reactivity of the alkoxylated amine catalysts, incorporation into the polymer scaffold occurs during the later reaction with isocyanates. The auto-reactivity of the tertiary amines formed endows the polyols with an auto-reactivity which can be usefully exploited in certain applications.

Without wishing to be tied to any one theory, it is believed that the polyether alcohols obtained using amines as catalysts have a construction which differs from the construction of polyether alcohols obtained using other catalysts. This different molecular construction has advantages in the manufacture of polyurethanes.

Therefore, the polyols of the invention have distinct advantages in polyurethane applications, particularly in the manufacturing process of polyurethane foams.

As mentioned, the polyether alcohols b1) are used in the manufacture of polyurethanes.

The Starting Materials Used for this May be More Particularly Described as Follows:

The organic polyisocyanates a) contemplated are preferably aromatic polyfunctional isocyanates.

Specific examples are: 2,4- and 2,6-tolylene diisocyanate (TDI) and the corresponding isomeric mixtures, 4,4′-, 2,4′- and 2,2′-diphenylmethane diisocyanate (MDI) and the corresponding isomeric mixtures, mixtures of 4,4′- and 2,4′-diphenylmethane diisocyanates and in the manufacture of rigid polyurethane foams particularly mixtures of 4,4′-, 2,4′- and 2,2′-diphenylmethane diisocyanates and polyphenyl polymethylene polyisocyanates (crude MDI).

The polyether alcohols of the present invention are typically used in admixture with other compounds having at least two hydrogen atoms reactive with isocyanate groups.

Compounds useful together with the polyether alcohols b1) used according to the present invention and having at least two isocyanate-reactive hydrogen atoms include particularly polyether alcohols and/or polyester alcohols having OH numbers in the range from 100 to 1200 mgKOH/g.

The polyester alcohols used together with the polyether alcohols b1) used according to the present invention are usually prepared by condensation of polyfunctional alcohols, preferably diols, having 2 to 12 carbon atoms and preferably 2 to 6 carbon atoms, with polyfunctional carboxylic acids having 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyether alcohols used together with the polyether alcohols b1) used according to the present invention usually have a functionality between 2 and 8 and more particularly from 3 to 8.

Particular preference is given to using polyether alcohols prepared by known methods, for example by anionic polymerization of alkylene oxides in the presence of catalysts, preferably alkali metal hydroxides.

The alkylene oxides used are mostly ethylene oxide and/or propylene oxide, preferably pure 1,2-propylene oxide.

The starter molecules used are in particular compounds having at least 3 and preferably from 4 to 8 hydroxyl groups or having at least two primary amino groups in the molecule.

By way of starter molecules having at least 3 and preferably from 4 to 8 hydroxyl groups in the molecule it is preferable to use trimethylolpropane, glycerol, pentaerythritol, sugar compounds such as for example glucose, sorbitol, mannitol and sucrose, polyhydric phenols, resols, for example oligomeric condensation products of phenol and formaldehyde, condensation products of aniline and formaldehyde (MDA), toluenediamine (TDA) and Mannich condensates of phenols, formaldehyde and dialkanolamines and also melamine.

The polyether alcohols have a functionality of preferably 3 to 8 and hydroxyl numbers of preferably 100 mgKOH/g to 1200 mgKOH/g and more particularly 120 mgKOH/g to 570 mgKOH/g.

By using difunctional polyols, for example polyethylene glycols and/or polypropylene glycols, having a molecular weight in the range between 500 to 1500 in the polyol component, the viscosity of the polyol component can be adapted.

The compounds having at least two isocyanate-reactive hydrogen atoms also include the optionally used chain extenders and crosslinkers. Rigid polyurethane foams can be manufactured with or without the use of chain-extending and/or crosslinking agents. The addition of difunctional chain-extending agents, trifunctional and higher-functional crosslinking agents or optionally also mixtures thereof may prove advantageous for modifying the mechanical properties. Chain-extending and/or crosslinking agents used are preferably alkanolamines and, more particularly, diols and/or triols having molecular weights of below 400, preferably in the range from 60 to 300.

Chain-extending agents, crosslinking agents or mixtures thereof are advantageously used in an amount of 1% to 20% by weight and preferably 2% to 5% by weight, based on the polyol component.

The polyurethane foams are typically manufactured in the presence of a blowing agent. The blowing agent used may preferably be water, which reacts with isocyanate groups by elimination of carbon dioxide. A further frequently used chemical blowing agent is formic acid which reacts with isocyanate by releasing carbon monoxide and carbon dioxide. So-called physical blowing agents can also be used in addition to or in lieu of chemical blowing agents. Physical blowing agents comprise usually room temperature liquid compounds which are inert toward the feed components and vaporize under the conditions of the urethane reaction. The boiling point of these compounds is preferably below 50° C. Physical blowing agents also include compounds which are gaseous at room temperature and are introduced into and/or dissolved in the feed components under pressure, examples being carbon dioxide, alkanes, more particularly low-boiling alkanes and fluoroalkanes, preferably alkanes, more particularly low-boiling alkanes and fluoroalkanes.

Physical blowing agents are usually selected from the group comprising alkanes and/or cycloalkanes having at least 4 carbon atoms, dialkyl ethers, esters, ketones, acetals, fluoroalkanes having 1 to 8 carbon atoms and tetraalkylsilanes having 1 to 3 carbon atoms in the alkyl chain, more particularly tetramethylsilane.

Examples are propane, n-butane, isobutane, cyclobutane, n-pentane, isopentane, cyclopentane, cyclohexane, dimethyl ether, methyl ethyl ether, methyl butyl ether, methyl formate, acetone, and also fluoroalkanes which can be degraded in the troposphere and therefore are harmless to the ozone layer, such as trifluoromethane, difluoromethane, 1,1,1,3,3-pentafluorobutane, 1,1,1,3,3-pentafluoropropane, 1,1,1,2,3-pentafluoropropene, 1-chloro-3,3,3-trifluoropropene, 1,1,1,2-tetrafluoroethane, difluoroethane and 1,1,1,2,3,3,3-heptafluoropropane, and also perfluoroalkanes, such as C3F8, C4F10, C5F12, C6F14, and C7F16. Particular preference is given to pentanes, more particularly cyclopentane. The physical blowing agents mentioned can be used alone or in any desired combination with one another.

A mixture of physical and chemical blowing agents can be used in a preferred embodiment of the invention. Particular preference is given to mixtures of physical blowing agents and water, more particularly hydrocarbons and water. Among hydrocarbons it is the pentanes—and of these especially cyclopentane—which are particularly preferred.

Manufacturing polyurethanes may be effected, if necessary, in the presence of catalysts, flame retardants and also customary auxiliary and/or added substances.

Further particulars concerning the starting compounds used may be found for example in Kunststoffhandbuch, volume 7 “Polyurethane”, edited by Günter Oertel, Carl-Hanser-Verlag Munich, 3rd edition, 1993.

The polyurethanes obtained by the process of the present invention comprise more particularly foamed polyurethanes and more preferably rigid foams. In one particular embodiment of the invention, the rigid foams have a compact skin and a cellular core, and are frequently also known as integral skin rigid foams or high density structural foams. Such foams are typically produced in a closed mold in the presence of a blowing agent. The combination of pressure and mold temperature causes the surface of the foam to densify into a skin. Such foams have numerous applications, for example in the automotive trim and spoiler region, profiles for, for example, windows, fittings, computer housings and filter pressure plates. Surface quality of the foam is decisive in these applications.

The rigid foams comprise for example those used for thermal insulation. The good compatibility of the polyether alcohols b1) with the blowing agents and the good flow behavior is advantageous here. It is generally advantageous for there to be good compatibility between the polyol mixture and the isocyanate. Poor polyol/isocyanate compatibility can in certain circumstances lead to separation of the reaction components, particularly in systems involving long reaction times, and this can in turn lead to a coarse cellularity for the foam and poor adherence of the foam to the substrate.

A further embodiment of the invention utilizes rigid foams in automotive construction, for example in the engine compartment or in the interior. There are engine compartment applications designed to absorb energy in the event of an accident. Rigid foam is used in the interior for back-foaming polymeric sheets, for example vinyl sheets. This is the case with side door trim or dashboards for example. Here the main advantage of the polyurethanes obtained by the inventive process resides in lower fogging.

Another advantage for reduced fogging is that, owing to the auto-reactivity of the polyether alcohols b1), the use quantity of catalyst, which is likewise a source of fogging, can be reduced.

A particular requirement in the manufacture of integral skin rigid foams, also known as thermoset foams, is good compatibility of the polyether alcohols b1) with the blowing agents, particularly hydrocarbons, such as cyclopentane.

The manufacture of thermoset foams further often utilizes fillers. A group of fillers are those having flame retardant properties, such as ammonium polyphosphate, encapsulated red phosphorus, or aluminum trihydrate.

A further class of fillers are inorganic salts, such as calcium carbonate, calcium sulfate or barium sulfate.

Further industrially important fillers are ground glass fibers, carbon fibers, carbon nanotubes, microspheres of glass, silicon, carbon black, wollastonite, talc, clay, pigments, such as titanium dioxide.

The examples which follow illustrate the invention.

### Preparing the Polyols

### EXAMPLE 1

### Inventive

A 960 I pressure reactor equipped with stirrer, jacket heating and cooling, metering devices for solid and liquid substances including alkylene oxides and also devices for nitrogen inertization and a vacuum system was heated to 80° C. to dry and repeatedly inertized with nitrogen. 102.75 kg of glycerol were added, the stirrer was started and 154.3 kg of sugar were metered. The reactor was heated to 95° C. Following addition of 6.03 kg of DMEOA, the metering of 541.57 kg of PO was started and the reactor temperature increased to 112° C. owing to the heat of reaction. Following a reaction completion time of 3 h at 90° C., the product was stripped at 100° C. in a nitrogen stream to obtain 776 kg of polyol having the following specifications:

Hydroxyl number 483 mg KOH/g
Viscosity 6600 mPas at 25° C.
Water content 0.023%

### EXAMPLE 2

### Comparative

A 960 I pressure reactor equipped with stirrer, jacket heating and cooling, metering devices for solid and liquid substances including alkylene oxides and also devices for nitrogen inertization and a vacuum system was heated to 88° C. to dry and repeatedly inertized with nitrogen. 91.18 kg of glycerol were added and the stirrer was started. Then, 3.32 kg of 48% KOH and 139.26 kg of sucrose were added. 96.91 kg of PO were metered at 105° C. Next the temperature was raised to 112° C. and a further 373.54 kg of PO were metered. Following a two hour postreaction period, the product was stripped at 100° C. with nitrogen and then admixed with water and neutralized with 80% phosphoric acid and filtered. The yield was 682 kg of polyol which, analytically, was characterized as follows:

Hydroxyl number 497 mg KOH/g
Viscosity 8400 mPas at 25° C.
Water content 0.016%

### Potassium 35.7 ppm

The viscosity of the polyols and of the polyol mixtures, unless otherwise stated, was determined at 25° C. using a Rheotec RC 20 rotary viscometer with spindle CC 25 DIN (spindle diameter: 12.5 mm; measuring cylinder internal diameter: 13.56 mm) at a shear rate of 50 1/s.

Hydroxyl numbers were determined according to DIN 53240.

### Determination of Pentane Solubility:

50 g of polyol or polyol mixture are introduced into a 100 mL glass vessel. A quantity of cyclopentane is added. Thereafter, the glass vessel is sealed, shaken vigorously for 5 minutes and then left to stand for one hour. Thereafter, the appearance of the sample is inspected. When the sample is clear, the test is repeated with more cyclopentane. When the mixture is cloudy, the test is repeated with less cyclopentane. In this way, the maximum amount of cyclopentane soluble in the polyol or polyol mixture is determined. This amount is the pentane solubility of the polyol or polyol mixture. The accuracy of this method is 1%.

TABLE 1
polyols used

| | | | Hydroxyl | Pentane | Viscos- |
|---|---|---|---|---|---|
| | Starter | | number | solubility | ity |
| Polyol | substance | Catalyst | mgKOH/g | % | [mPas] |
| 1 | sucrose/glycerol | DMEOA | 483 | 12 | 6600 |
| | PO, Fn = 4.3 | | | | |
| 2 | sucrose/glycerol | KOH | 497 | <10 | 8400 |
| | PO, Fn = 4.3 | | | | |
| 3 | glycerol PO | KOH | 230 | not | not |
| | | | | relevant | relevant |

Fn—average functionality
PO—propylene oxide

### Isocyanate Compatibility:

Polymeric MDI, such as Lupranat® M20 from BASF SE, (isocyanate (I)) and the polyols used for the process of the present invention are typically not miscible. Isocyanate (II), a 4,4′-MDI-based prepolymer having an NCO content of 23% by weight, commercially available as Lupranat® MP102, is fully miscible with these polyols. Mixtures of isocyanates I and II may or may not be miscible with these polyols, depending on their mixing ratio. This is the basis for the method of determining the miscibility of polyols with isocyanates. The procedure adopted is as follows: 1.00 g of the polyol is placed on a watch glass having a diameter of 4 cm. Thereafter, 1.00 g of the mixture of isocyanate I and isocyanate II is added, followed by stirring with a spatula for one minute so as not to form air bubbles by the stirring. One minute after stirring is ended, the sample was visually inspected. The mixture appears either cloudy or clear. When the mixture is cloudy, the test is repeated with a larger proportion of isocyanate II in the mixture. When the mixture is clear, the test is repeated with a larger proportion of isocyanate I in the mixture. In this way, the maximum amount of isocyanate I in the mixture at which the mixture is still just clear is determined. The accuracy for determining the amount of isocyanate I in the mixture is 2%.

In the case of inventive polyol 1, the mixing ratio of isocyanates I:II was 15/85. For the comparative polyol, the mixing ratio of isocyanates I:II was 5/95.

### EXAMPLE 3

### Rigid Foam Application

### Foam Production for Mechanical Testing

A base foam system comprising 100 pbw of polyol or polyol mixture, 2.4 pbw of Tegostab® B 8467 surfactant from Goldschmidt and 0.85 pbw of water is taken as the starting point. Dimethylcyclohexylamine and cyclopentane were used as catalyst and blowing agent, and polymer MDI (Lupranat® M20 from BASF SE) as isocyanate. The foam was produced at an isocyanate index of 100. The starting materials were hand mixed. The amount of dimethylcyclohexylamine was determined such that the foam had a gel time of 55 seconds. The amount of cyclopentane was determined such that the foam had a free foam density of 35 kg/m. Of this recipe, a foam sample of 500 g was produced in an 11.4 L cube-shaped steel mold. The sample was demolded after 20 minutes. Thereafter the sample was stored for 3 days and then tested. Density was determined according to the ISO 845 standard and compressive strength according to the ISO 604 standard.

TABLE 2
foam formulations

| | | | |
|---|---|---|---|
| polyol 1 | parts | 100 | |
| polyol 2 | parts | | 100 |
| Tegostab B 8467 | parts | 2.4 | 2.4 |
| DMCHA | parts | 5 | 5.2 |
| distilled water | parts | 0.85 | 0.85 |
| CP | parts | 14.5 | 14.8 |
| cup test | | | |
| setting time | s | 55 | 56 |
| density | kg/m³ | 38 | 38 |
| cube | | | |
| compressive strength/stress | N/mm² | 0.27 | 0.28 |
| core density | kg/m³ | 34.5 | 35 |

In explanation of Table 2: in foaming, the inventive polyol exhibited autocatalytic properties and needed less catalyst and less blowing agent to reach the same density.

### EXAMPLE 4

### Thermoset Application

TABLE 3
effect of catalyst quantity on reactivity

| | | | | | | | |
|---|---|---|---|---|---|---|---|
| polyol 1 | parts by weight | | 87.7 | | 87.7 | | 87.7 |
| polyol 2 | parts by weight | 87.7 | | 87.7 | | 87.7 | |
| polyol 3 | parts by weight | 7.8 | 7.8 | 7.8 | 7.8 | 7.8 | 7.8 |
| Tegostab B 2219 | parts by weight | 1.5 | 1.5 | 1.5 | 1.5 | 1.5 | 1.5 |
| tap water | parts by weight | 1.9 | 1.9 | 1.9 | 1.9 | 1.9 | 1.9 |
| Dabco 33 LV | parts by weight | 1.1 | 1.1 | 0.5 | 0.5 | 0.25 | 0.25 |
| cup test | | | | | | | |
| setting time | s | 133 | 94 | 305 | 150 | 540 | 190 |

In explanation of Table 3: in foaming, the inventive polyol exhibited autocatalytic properties and needs less catalyst than the noninventive polyol. This effect increased with lower catalyst concentration.

TABLE 4
effect of fillers on viscosity

| | | | | | | | | | |
|---|---|---|---|---|---|---|---|---|---|
| polyol 1 | parts by weight | | 87.7 | | 83.3 | | 78.9 | | 70.2 |
| polyol 2 | parts by weight | 87.7 | | 83.3 | | 78.9 | | 70.2 | |
| polyol 3 | parts by weight | 7.8 | 7.8 | 7.4 | 7.4 | 7.0 | 7.0 | 6.2 | 6.2 |
| Tegostab B 2219 | parts by weight | 1.5 | 1.5 | 1.4 | 1.4 | 1.4 | 1.4 | 1.2 | 1.2 |
| tap water | parts by weight | 1.9 | 1.9 | 1.8 | 1.8 | 1.7 | 1.7 | 1.5 | 1.5 |
| Dabco 33 LV | parts by weight | 1.1 | 1.1 | 1.0 | 1.0 | 1.0 | 1.0 | 0.9 | 0.9 |
| CaCO3 | parts by weight | 0.0 | 0.0 | 5.0 | 5.0 | 10.0 | 10.0 | 20.0 | 20.0 |
| viscosity at 20° C. | mPas | 8200 | 6700 | 9100 | 7300 | 9800 | 8000 | 12000 | 9700 |

Polyol viscosity was determined at 20° C. in accordance with ISO 3219. In explanation of Table 4: various fillers were added. The intrinsic viscosity of inventive polyols is also measurable in filled systems.

### Plate Fabrication:

The A component is made up and left to stand for half an hour at least. Following isocyanate addition, the mixture is mechanically stirred at max. stirrer speed for 13 s. The mixture is then poured into a hot mold (20×15×1 cm) at 50° C. After 5 min, the plate is demolded.

TABLE 5
foam recipe and mechanical properties of plate

| System | | 1 | 2 |
|---|---|---|---|
| polyol 1 | | 87.7 | |
| polyol 2 | | | 87.7 |
| polyol 3 | parts | 7.8 | 7.8 |
| Tegostab B 2219 | parts | 1.5 | 1.5 |
| tap water | parts | 1.9 | 1.9 |
| Dabco 33 LV | parts | 1.1 | 1.1 |
| plate | | | |
| density | kg/m³ | 285 | 280 |
| Shore D hardness | | 30 | 30 |
| bending strength/stress | N/mm2 | 8.3 | 8.1 |
| sag | mm | 20.6 | 20.2 |

### Evaluation of Surface Quality:

A sheet of A4 paper is placed on the plates and traced with a round carbon rod using the flat side. The sheet was put in a scanner, binarized with defined threshold values and small pixels were removed. Thereafter, the area proportion of the (black) elevations was determined. The proportion of elevations is 1% for system 1 (of the invention) and 22% for system 2 (prior art).

We claim:

1. A process for preparing polyurethanes, which comprises reacting
a) polyisocyanates with
b) compounds having at least two hydrogen atoms reactive with isocyanate groups,
wherein said compounds having at least two hydrogen atoms reactive with isocyanate groups b) comprise at least one polyether alcohol b1) having a functionality of 2-8 and a hydroxyl number of 200-600 mgKOH/g, obtained by addition of an alkylene oxide b1b) onto a compound having at least two hydrogen atoms reactive with alkylene oxides by using an amine b1c) as catalyst.

2. The process according to claim 1 wherein said polyether alcohol b1) is used in an amount of 10-90% by weight, based on the weight of said component b).

3. The process according to claim 1 wherein said compound having at least two hydrogen atoms reactive with alkylene oxides used for preparing said polyether alcohol b1) comprises a mixture comprising at least one compound b1ai) which is solid at room temperature.

4. The process according to claim 1 wherein said compound b1ai) is selected from the group comprising pentaerythritol, glucose, sorbitol, mannitol, sucrose, polyhydric phenols, resols, condensates of aniline and formaldehyde, toluenediamine, Mannich condensates of phenols, formaldehyde and dialkanolamines, melamine and also mixtures of at least two of the recited compounds.

5. The process according to claim 1 wherein said compound b1a) is selected from the group comprising sucrose, sorbitol and pentaerythritol.

6. The process according to claim 1 wherein said compound having at least two hydrogen atoms reactive with alkylene oxides b1a) used for preparing said polyether alcohol b1) comprises a mixture comprising at least one compound b1aii) which is liquid at room temperature.

7. The process according to claim 1 wherein said compound b1aii) is selected from the group comprising glycerol, monofunctional alcohols of 1-20 carbon atoms, propylene glycol and its higher homologs, ethylene glycol and its higher homologs and also mono-, di- or trialkanolamines.

8. The process according to claim 1 wherein said compound b1a) comprises a mixture of at least one compound b1ai) which is solid at room temperature and at least one compound b1aii) which is liquid at room temperature.

9. The process according to claim 1 wherein said amine b1c) is selected from the group comprising trialkylamines, aromatic amines, pyridine, imidazoles, guanidine, alkylated guanidines, amidines.

10. The process according to claim 1 conducted in the presence of a blowing agent c).

11. The process according to claim 1 utilizing water as blowing agent.

12. The process according to claim 1 utilizing a physical blowing agent.

13. The process according to claim 1 wherein said physical blowing agent is selected from the group comprising alkanes and fluoroalkanes.

14. The process according to claim 1 conducted in the presence of a filler.

15. The process according to claim 1 wherein said filler is an inorganic salt.

16. The process according to claim 1 wherein said filler is selected from the group comprising ammonium polyphosphate, encapsulated red phosphorus and aluminum trihydrate.

17. The process according to claim 1 wherein said filler is selected from the group comprising ground glass fibers, carbon fibers, carbon nanotubes, microspheres of glass, silicon, carbon black, wollastonite, talc, clay and pigments.

18. The process according to claim 1 wherein the polyurethane foam is produced in a closed mold.

19. A polyurethane obtainable according to any of claims 1-16.
